(19) United States
(12) Patent Application Publication
(10) Pub. No.: US 2026/0192353 A1
(43) Pub. Date: Jul. 9, 2026

(54) CYLINDRICAL MEMBER AND MANUFACTURING METHOD THEREFOR

(71) Applicant: NIPPON STEEL CORPORATION, Tokyo (JP)

(72) Inventors: Atsushi SUGAMA, Chiyoda-ku, Tokyo (JP); Katsuhide NISHIO, Chiyoda-ku, Tokyo (JP)

(73) Assignee: NIPPON STEEL CORPORATION, Tokyo (JP)

(21) Appl. No.: 19/131,815

(22) PCT Filed: Nov. 27, 2023
(86) PCT No.: PCT/JP2023/042355

§ 371 Date: May 21, 2025

(30) Foreign Application Priority Data
Dec. 7, 2022 (JP) 2022-195596

(51) Int. Cl. B21D 51/10

(52) U.S. Cl. CPC B21D 51/10

(57) ABSTRACT

A method for manufacturing a cylindrical member includes a preparation step and a processing step. In the preparation step, a workpiece material is prepared. In the processing step, the workpiece material is pressed in the axial direction of the workpiece material by an axial press die. In addition, in the processing step, a bead is formed on a circumferential wall by pressing a plate die into the circumferential wall while rotating the workpiece material about the central axis relative to the plate die. An end surface of the plate die includes arc-shaped shoulder portions. When each radius of curvature of the shoulder portions is represented by Rp, the plate thickness of the circumferential wall is represented by t, and the pressing amount of the plate die is represented by X, Rp, t, and X satisfy the following formulae (1) and (2): 0.20≤Rp/t (1), X/Rp≤20.5 (2).

### TECHNICAL FIELD

The present disclosure relates to a cylindrical member and a method for manufacturing the same.

### BACKGROUND ART

A circumferential wall of a cylindrical member such as a battery may be provided with an annular bead. The bead has a shape inwardly protruding in the radial direction of the cylindrical member, and extends in the circumferential direction of the cylindrical member. For example, a component to be disposed inside the cylindrical member is placed on the bead.

Patent Literature 1 discloses a technique for conducting bead processing on an exterior can containing an electrode group. In Patent Literature 1, a beading roller is pressed against a bottomed exterior can at a position near an open end of the exterior can while the exterior can is compressed in the axial direction. The beading roller is pressed against the exterior can while being revolved about the central axis of the exterior can. Thus, an annular bead is formed on the exterior can.

Patent Literature 2 also discloses a technique for conducting bead processing on a bottomed cylindrical battery can. In Patent Literature 2, a beading roller is moved toward a battery can while the battery can is rotated about its central axis in a state in which the battery can is pressed from above and below. An annular bead is formed on the battery can by pressing the beading roller into the battery can. In Patent Literature 2, the ratio of the moving speed of the beading roller to the rotational speed of the battery can is set to be constant, specifically, about 0.040 (mm/revolution number).

In Patent Literature 3, an annular bead is formed on a battery can by abutting each of abutment portions of first and second blades against the battery can while rotating the battery can about its central axis in a state in which the battery can is pressed from both sides in the axial direction. The abutment portion of the first blade and the abutment portion of the second blade each include a large-diameter abutment portion with an arc-shaped cross section and a small-diameter abutment portion with an arc-shaped cross section having a smaller diameter than the arc-shaped cross section of the large-diameter abutment portion. In the formation of a bead, first, the large-diameter abutment portion is abutted against the battery can. Thereafter, the small-diameter abutment portion is abutted against the battery can by sliding the first and second blades.

### CITATION LIST

### Patent Literature

Patent Literature 1: JP H8-31393A
Patent Literature 2: JP H10-255730A
Patent Literature 3: JP 2004-220940A

### SUMMARY OF INVENTION

### Technical Problem

As described in each patent literature, an annular bead is formed by pressing the circumferential wall of a cylindrical workpiece material in the radial direction while pressing the workpiece material in the axial direction. However, conventionally, a phenomenon often occurs in which a bead cracks or a bead buckles and undulates in the circumferential direction of the workpiece material, resulting in a problem in that a bead cannot be accurately formed.

An object of the present disclosure is to provide a method for manufacturing a cylindrical member, with which the formation of a crack and the occurrence of buckling in a bead can be suppressed.

### Solution to Problem

A method for manufacturing a cylindrical member according to the present disclosure includes a preparation step and a processing step. In the preparation step, a cylindrical workpiece material is prepared. In the processing step, the workpiece material is pressed in an axial direction of the workpiece material by an axial press die. In the processing step, in addition to the operation above, a plate die disposed outside of a circumferential wall of the workpiece material in a radial direction of the workpiece material is pressed into the circumferential wall while the workpiece material is rotated about a central axis relative to the plate die, and thereby a bead is formed on the circumferential wall. The bead has a shape inwardly protruding in the radial direction of the workpiece material, and extends in a circumferential direction of the workpiece material. In a cross-sectional view taken along a thickness direction of the plate die, the plate die includes a first surface, a second surface, and an end surface. The first surface extends in the radial direction of the workpiece material and has a linear shape. The second surface is located on a side opposite to the first surface. The second surface extends in the radial direction of the workpiece material and has a linear shape. The end surface connects the first surface and the second surface and faces the circumferential wall. The end surface includes an arc-shaped first shoulder portion and an arc-shaped second shoulder portion. The first shoulder portion is continuous with the first surface. The second shoulder portion is continuous with the second surface. When a radius of curvature of each of the first shoulder portion and the second shoulder portion is represented by Rp, a plate thickness of the circumferential wall is represented by t, and a pressing amount of the plate die in the processing step is represented by X, Rp, t, and X satisfy formulae (1) and (2) below.

0.20≤Rp/t (1)

X/Rp≤20.5 (2)

### Advantageous Effects of Invention

With the method for manufacturing a cylindrical member according to the present disclosure, it is possible to suppress the formation of a crack and the occurrence of buckling in a bead.

### BRIEF DESCRIPTION OF DRAWINGS

FIG. 1 is a perspective view of a cylindrical member according to a first embodiment.

FIG. 2A is a schematic diagram for illustrating a method for manufacturing the cylindrical member according to the first embodiment.

FIG. 2B is a schematic diagram for illustrating the method for manufacturing the cylindrical member according to the first embodiment.

FIG. 2C is a schematic diagram for illustrating the method for manufacturing the cylindrical member according to the first embodiment.

FIG. 2D is a schematic diagram for illustrating the method for manufacturing the cylindrical member according to the first embodiment.

FIG. 2E is a schematic diagram for illustrating the method for manufacturing the cylindrical member according to the first embodiment.

FIG. 2F is a schematic diagram for illustrating the method for manufacturing the cylindrical member according to the first embodiment.

FIG. 2G is a schematic diagram for illustrating the method for manufacturing the cylindrical member according to the first embodiment.

FIG. 3A is a schematic diagram for illustrating a method for manufacturing a cylindrical member according to a second embodiment.

FIG. 3B is a schematic diagram for illustrating the method for manufacturing the cylindrical member according to the second embodiment.

FIG. 4 is a cross-sectional view of a portion of the cylindrical member according to the second embodiment.

FIG. 5 is a cross-sectional view showing a modified example of a plate die to be used in the methods for manufacturing a cylindrical member according to the embodiments above.

### DESCRIPTION OF EMBODIMENTS

In the formation of an annular bead on a cylindrical workpiece material, the workpiece material is pressed in its axial direction by an axial press die. Also, a plate die is pressed into the circumferential wall of the workpiece material inward in the radial direction while the workpiece material is rotated relative to the plate die about the central axis of the workpiece material. The end surface of the plate die typically includes a shoulder portion that is continuous with the surface of the plate die. The shoulder portion has a substantially arc shape in the cross-sectional view of the plate die.

As described above, conventionally, in the formation of a bead on a circumferential wall of a workpiece material, the bead may crack. The harder a metal constituting the workpiece material is, the more likely it is that the bead cracks. Even if the bead does not crack, the bead may buckle in the circumferential direction of the workpiece material.

The inventors of the present invention investigated the main factor that has an adverse influence on the bead processing, and found that the shape of the plate die and the pressing amount of the plate die pressed into the workpiece material were closely associated with the formation of a crack and the occurrence of buckling in the bead. Specifically, if the radius of curvature of the shoulder portion present on the end surface of the plate die is too small relative to the plate thickness of the workpiece material, tensile strain will concentrate on the distal end portion of the bead, causing a crack at the distal end portion of the bead. If the pressing amount of the plate die pressed into the circumferential wall of the workpiece material is too large relative to the radius of curvature of the shoulder portion, tensile stress generated at the distal end portion of the bead will be too large, causing a crack at the distal end portion of the bead. Meanwhile, if the pressing amount of the plate die pressed into the circumferential wall of the workpiece material is too large relative to the radius of curvature of the shoulder portion, the circumferential length of the bead will be excessively reduced and thus the excessive amount of the material will be present at the bead, causing buckling of the bead in the circumferential direction of the workpiece material. Accordingly, the inventors of the present invention further carried out intensive studies, and revealed the conditions for the radius of curvature of the end-surface shoulder portion of the plate die and the pressing amount of the plate die pressed into the workpiece material under which both the formation of a crack and the occurrence of buckling can be suppressed, and thus a method for manufacturing a cylindrical member according to an embodiment was achieved.

A method for manufacturing a cylindrical member according to an embodiment includes a preparation step and a processing step. In the preparation step, a cylindrical workpiece material is prepared. In the processing step, the workpiece material is pressed in an axial direction of the workpiece material by an axial press die. In the processing step, in addition to the operation above, a plate die disposed outside of a circumferential wall of the workpiece material in a radial direction of the workpiece material is pressed into the circumferential wall while the workpiece material is rotated about a central axis relative to the plate die, and thereby a bead is formed on the circumferential wall. The bead has a shape inwardly protruding in the radial direction of the workpiece material, and extends in a circumferential direction of the workpiece material. In a cross-sectional view taken along a thickness direction of the plate die, the plate die includes a first surface, a second surface, and an end surface. The first surface extends in the radial direction of the workpiece material and has a linear shape. The second surface is located on a side opposite to the first surface. The second surface extends in the radial direction of the workpiece material and has a linear shape. The end surface connects the first surface and the second surface and faces the circumferential wall. The end surface includes an arc-shaped first shoulder portion and an arc-shaped second shoulder portion. The first shoulder portion is continuous with the first surface. The second shoulder portion is continuous with the second surface. When a radius of curvature of each of the first shoulder portion and the second shoulder portion is represented by Rp, a plate thickness of the circumferential wall is represented by t, and a pressing amount of the plate die in the processing step is represented by X, Rp, t, and X satisfy formulae (1) and (2) below (first configuration).

$$0.2 \leq Rp / t \qquad ( 1 )$$

$$X / Rp \leq 20.5 \qquad ( 2 )$$

In the method for manufacturing a cylindrical member according to the first configuration, the ratio (Rp/t) between the plate thickness t of the circumferential wall of the workpiece material and the radius of curvature Rp of the shoulder portion present at the end surface of the plate die is 0.20 or greater. That is to say, the radius of curvature Rp of the end-surface shoulder portion of the plate die is set to be relatively large relative to the plate thickness t of the circumferential wall of the workpiece material. In this case, in the formation of a bead by pressing the plate die into the circumferential wall of the workpiece material, a region into which tensile strain is to be introduced by the end-surface shoulder portion of the plate die is large in size. Accordingly, when the tensile strain amounts are the same, the tensile strain is more likely to be dispersed at the distal end portion of the bead compared with a case where the radius of curvature Rp is small relative to the plate thickness t. In other words, it is possible to reduce the tensile strain amount per unit area. In addition, since the plate thickness t of the circumferential wall of the workpiece material is relatively small relative to the radius of curvature Rp of the end-surface shoulder portion of the plate die, the surface line length of the bead is not excessively large relative to the length of the neutral axis of bending, thus making it possible to reduce the tensile strain amount at the distal end portion of the bead. Furthermore, in the method for manufacturing a cylindrical member according to the first configuration, the ratio (X/Rp) between the radius of curvature Rp of the end-surface shoulder portion of the plate die and the pressing amount X of the plate die pressed into the circumferential wall of the workpiece material is 20.5 or smaller. That is to say, the pressing amount X of the plate die is not too large relative to the radius of curvature Rp of the end-surface shoulder portion of the plate die. Accordingly, the tensile stress generated at the end-surface shoulder portion of the plate die is reduced. Therefore, it is possible to suppress the formation of a crack in the bead. Also, necking defects in the bead are less likely to occur.

In the method for manufacturing a cylindrical member according to the first configuration, the ratio (X/Rp) between the radius of curvature Rp of the end-surface shoulder portion of the plate die and the pressing amount X of the plate die pressed into the circumferential wall of the workpiece material is 20.5 or smaller. In this case, the pressing amount X of the plate die is not too large relative to the radius of curvature Rp of the end-surface shoulder portion of the plate die, and the circumferential length of the annular bead formed using the plate die is not excessively reduced. Accordingly, it is less likely that an excessive amount of the material is present at the bead, thus making it possible to suppress a phenomenon in which the bead buckles and undulates in the circumferential direction of the workpiece material.

As described above, with the method for manufacturing a cylindrical member according to the first configuration, it is possible to suppress the formation of a crack and the occurrence of buckling in a bead.

When a pressing speed of the axial press die is represented by V1 and a pressing speed of the plate die is represented by V2 in the processing step, it is preferable that V1 and V2 satisfy a formula (3) below (second configuration).

$$1.5 \leq V 2 / V 1 \qquad ( 3 )$$

In the second configuration, the ratio (V2/V1) between the pressing speed V1 of the axial press die pressing the workpiece material in the axial direction and the pressing speed V2 of the plate die pressed into the workpiece material in the radial direction is 1.5 or greater. That is to say, the pressing speed V1 of pressing against the workpiece material in the axial direction is not too large relative to the pressing speed V2 of pressing into the workpiece material in the radial direction, thus making it possible to suppress the occurrence of the surplus material at the bead caused through excessive pressing in the axial direction. This can suppress a phenomenon in which a gap is formed between the distal end portion of the bead and the plate die due to plastic buckling and a bead having a desired shape is not obtained (so-called poor die conformability).

In the manufacturing method according to the first configuration or the second configuration, pressing using the plate die may be conducted a plurality of times in the processing step. In this case, when, in a cross-sectional view taken along the thickness direction of the plate die to be used for n-th pressing, a surface line length of a portion to be pressed into the circumferential wall is represented by Lp(n) and a radius of curvature of each of the first shoulder portion and the second shoulder portion is represented by Rp(n), and in a cross-sectional view taken along the thickness direction of the plate die to be used for (n-1)th pressing, a surface line length of a portion to be pressed into the circumferential wall is represented by Lp(n-1) and a radius of curvature of each of the first shoulder portion and the second shoulder portion is represented by Rp(n-1), it is preferable that Lp(n), Rp(n), Lp(n-1), and Rp(n-1) satisfy formulae (4) and (5) below (third configuration).

$$Lp ( n ) \leq Lp ( n - 1 ) \times 1.1 \qquad ( 4 )$$

$$Rp ( n ) < Rp ( n - 1 ) \qquad ( 5 )$$

In the third configuration, the bead processing using the plate die is conducted a plurality of times. Specifically, in the (n-1)th bead processing, a plate die with a relatively large radius of curvature of the end-surface shoulder portion is pressed into the circumferential wall of the workpiece material, and in the subsequent n-th bead processing, a plate die with a relatively small radius of curvature of the end-surface shoulder portion is used and pressed into the circumferential wall of the workpiece material, so that an increase from the cross-sectional line length of the bead after the (n-1)th bead processing is suppressed. As described above, the circumferential wall of the workpiece material is subjected to the stepwise bead processing with the radius of curvature being changed from a relatively large one to a relatively small one, thus making it possible to suppress a decrease in the plate thickness of the circumferential wall caused by the bead processing. Accordingly, the bead is less likely to crack.

In the manufacturing method according to any one of the first configuration to the third configuration, the workpiece material may be made of a steel material having a tensile strength of 290 MPa or more (fourth configuration).

In the manufacturing method according to any one of the first configuration to the fourth configuration, the cylindrical member may be a battery. The workpiece can have a bottomed cylindrical shape and contain an electrode body. In this case, the method for manufacturing a cylindrical member may further include a step of placing a sealing body on the bead formed on the circumferential wall and bending an end portion of the circumferential wall in the axial direction inward in the radial direction to fix the sealing body to the workpiece material (fifth configuration).

A cylindrical member according to an embodiment includes a circumferential wall and a bead. The circumferential wall has a cylindrical shape. The bead has a shape inwardly protruding from the circumferential wall in a radial direction of the circumferential wall. The bead extends in a circumferential direction of the circumferential wall. A plate thickness of a distal end portion of the bead is 80% or more and 100% or less of a plate thickness of the circumferential wall (sixth configuration).

Hereinafter, embodiments of the present disclosure will be described with reference to the drawings. In the drawings, the same or corresponding configurations are denoted by the same reference signs, and repeated descriptions will not be given.

### First Embodiment

### [Cylindrical Member]

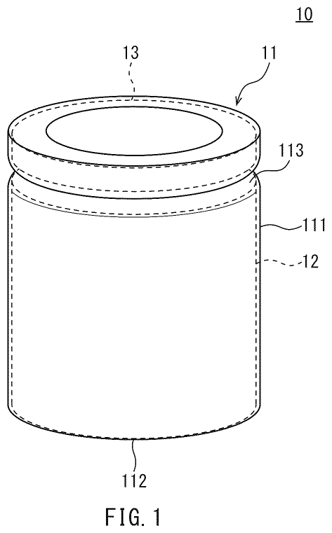

FIG. 1 is a schematic perspective view showing a cylindrical member 10 according to this embodiment. The cylindrical member 10 is, for example, a battery. The cylindrical member 10 may also be a pipe, a pipe joint, or the like. In this embodiment, an example in which the cylindrical member 10 is a battery will be described.

As shown in FIG. 1, the cylindrical member 10 includes a battery case 11, an electrode body 12, and a sealing body 13. The battery case 11 includes a circumferential wall 111, a bottom plate 112, and a bead 113. The circumferential wall 111 has a substantially cylindrical shape. The bottom plate 112 blocks one end of the circumferential wall 111 in the axial direction. The bead 113 is disposed on the other end side of the circumferential wall 111 in the axial direction. The bead 113 is provided on the circumferential wall 111. The bead 113 has a shape protruding inward from the circumferential wall 111 in the radial direction of the circumferential wall 111. The bead 113 extends in the circumferential direction of the circumferential wall 111. The bead 113 extends over the entire circumference of the circumferential wall 111. That is to say, the bead 113 has an annular shape.

The battery case 11 is made of a metal. An example of the metal constituting the battery case 11 is steel. The steel includes plated steel and stainless steel. The battery case 11 is preferably made of nickel-plated steel. However, the battery case 11 may be made of a metal other than steel. The metal constituting the battery case 11 may be, for example, aluminum, titanium, or copper, or an alloy thereof.

The electrode body 12 is housed in the battery case 11. The electrode body 12 is disposed between the bottom plate 112 and the bead 113 in the axial direction of the circumferential wall 111. The electrode body 12 is a known electrode body selected according to the type of battery. For example, when the cylindrical member 10 is a lithium ion secondary battery, the electrode body 12 is an electrode body for a lithium-ion secondary battery.

The sealing body 13 is housed in the battery case 11. The sealing body 13 is placed on the bead 113 inside the circumferential wall 111. The sealing body 13 is crimped and fixed to the battery case 11. More specifically, the sealing body 13 is fixed to the battery case 11 by bending the end portion of the circumferential wall 111 of the battery case 11 inward near the sealing body 13. The sealing body 13 is a known sealing body generally used for a battery.

### [Method for Manufacturing Cylindrical Member]

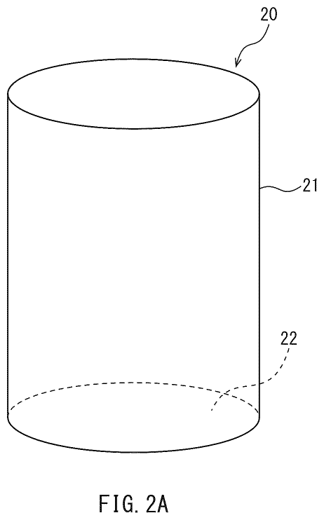

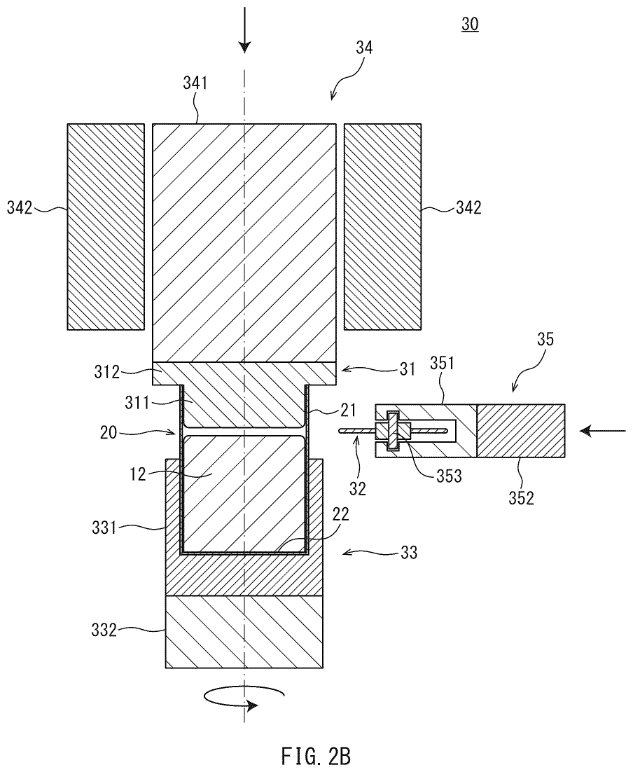

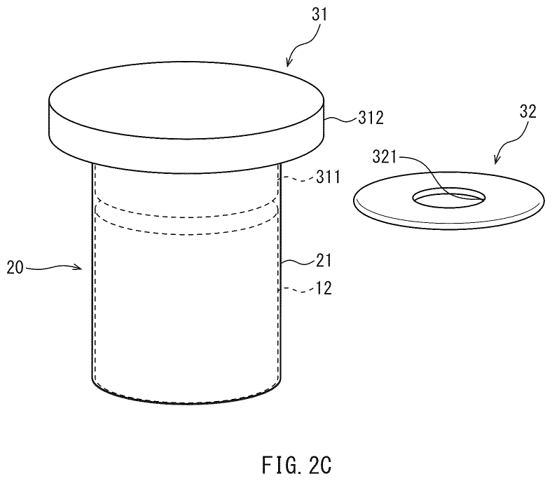

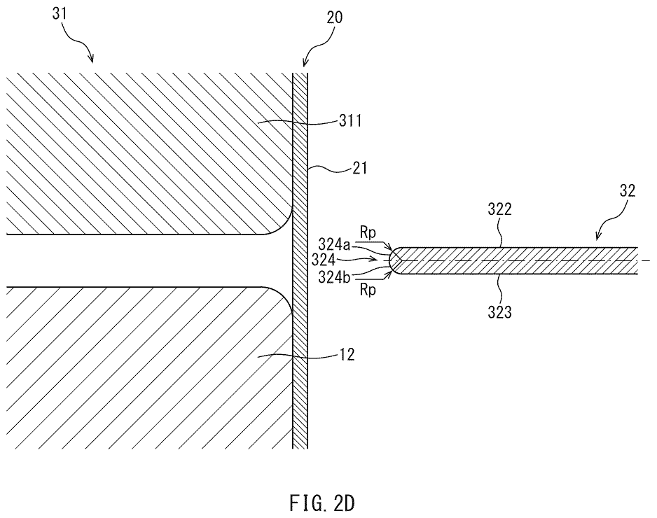

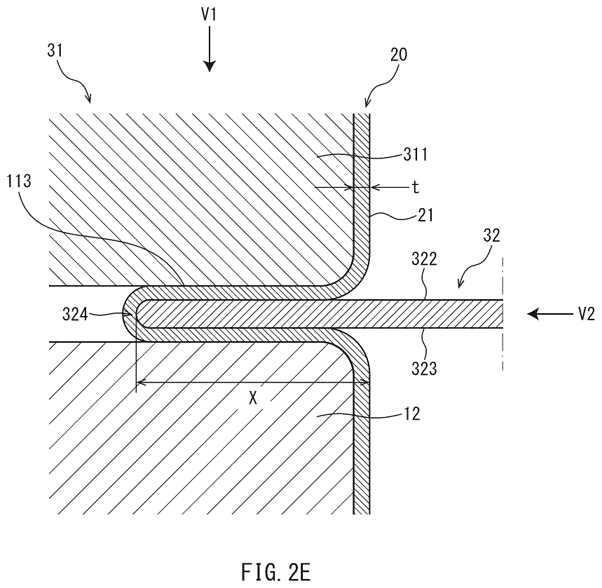

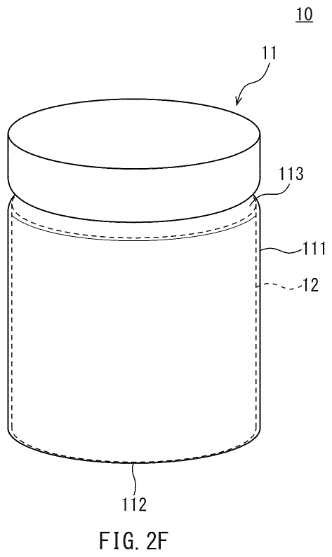

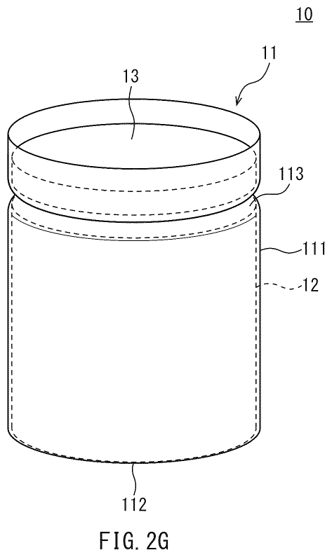

Hereinafter, a method for manufacturing the cylindrical member 10 will be described with reference to FIG. 2A to FIG. 2G. The method for manufacturing the cylindrical member 10 includes a preparation step and a processing step. In this embodiment, the method for manufacturing the cylindrical member 10 further includes a crimping step.

### (Preparation Step)

As illustrated in FIG. 2A, a workpiece material 20 is prepared in the preparation step. In this embodiment, the workpiece material 20 has a bottomed cylindrical shape. That is to say, the workpiece material 20 includes a cylindrical circumferential wall 21 and a bottom plate 22 that blocks one end of the circumferential wall 21 in the axial direction. The other end of the circumferential wall 21 in the axial direction is an open end. The workpiece material 20 is a material for the battery case 11 above (FIG. 1).

The workpiece material 20 is made of, for example, a steel material. The workpiece material 20 may be made of a plated steel material, a stainless steel material, or the like. When the cylindrical member 10 (FIG. 1) to be produced is a battery as in this embodiment, the workpiece material 20 is preferably made of a nickel-plated steel material. The steel material constituting the workpiece material 20 can have a tensile strength of 290 MPa or more. The steel material may have a tensile strength of 300 MPa or more, 330 MPa or more, or 350 MPa or more. The steel material may have a tensile strength of 380 MPa or more or 400 MPa or more. The bottomed cylindrical workpiece material 20 can be formed by conducting, for example, drawing processing on a steel plate.

However, the workpiece material 20 need not necessarily be made of a steel material. The workpiece material 20 need only be made of metal. The workpiece material 20 may also be made of, for example, aluminum, titanium, or copper, or an alloy thereof.

In the workpiece material 20, the circumferential wall 21 and the bottom plate 22 have a thickness (plate thickness) of, for example, 0.1 mm or more. The circumferential wall 21 and the bottom plate 22 have a plate thickness of, for example, 3.0 mm or less.

### (Processing Step)

The processing step is a step of conducting bead processing on the circumferential wall 21 of the workpiece material 20. First, an example of a processing apparatus 30 that can be used in the processing step will be described with reference to FIG. 2B.

As shown in FIG. 2B, the processing apparatus 30 includes an axial press die 31 and a plate die 32. The axial press die 31 and the plate die 32 are typically made of a metal. The processing apparatus 30 further includes a holding device 33 for holding the workpiece material 20, and driving devices 34 and 35 for driving the axial press die 31 and the plate die 32, respectively.

The holding device 33 includes a holder 331 and a rotor 332. The holder 331 holds the workpiece material 20. On the sheet of FIG. 2B, the workpiece material 20 is held by the holder 331 with the bottom plate 22 located on the lower side. The rotor 332 is attached to the holder 331. The rotor 332 rotates the holder 331 holding the workpiece material 20 about the central axis of the workpiece material 20. The rotor 332 need only be capable of transmitting rotational motion to the holder 331, and may be, for example, a hydraulic actuator or an electric motor.

In the example shown in FIG. 2B, the workpiece material 20 contains the electrode body 12. That is to say, the electrode body 12 is disposed in a space formed by the circumferential wall 21 and the bottom plate 22. The electrode body 12 is close to or is in contact with the inner circumferential surface of the circumferential wall 21. The holding device 33 holds the workpiece material 20 containing the electrode body 12.

The axial press die 31 is disposed so as to face the holding device 33 in the axial direction of the workpiece material 20. In an example of this embodiment, the axial press die 31 includes a small-diameter portion 311 and a large-diameter portion 312. The small-diameter portion 311 and the large-diameter portion 312 each have a columnar shape.

The small-diameter portion 311 is inserted into the inside of the circumferential wall 21 of the workpiece material 20. The small-diameter portion 311 is close to or is in contact with the inner circumferential surface of the circumferential wall 21. The small-diameter portion 311 faces the electrode body 12 with a gap therebetween in the axial direction of the workpiece material 20. The large-diameter portion 312 is connected to the small-diameter portion 311 on a side opposite to the electrode body 12. The diameter of the large-diameter portion 312 is larger than the diameter of the small-diameter portion 311.

The axial press die 31 is configured to be capable of being moved close to and away from the holding device 33 by the driving device 34. The driving device 34 includes a cylinder 341 and a cylinder guide 342. The cylinder 341 is connected to the large-diameter portion 312 of the axial press die 31. The cylinder 341 is configured to be capable of being stretched and contracted. Due to stretch or contraction of the cylinder 341, the axial press die 31 is moved in the axial direction of the workpiece material 20 held by the holding device 33. The cylinder 341 may be a hydraulic cylinder or electric cylinder.

The plate die 32 is disposed on the outside in the radial direction with respect to the circumferential wall 21 of the workpiece material 20 held by the holding device 33. The plate die 32 is configured to be capable of being moved close to and away from the circumferential wall 21 of the workpiece material 20 by the driving device 35. The driving device 35 includes a holder 351 and a cylinder 352. The holder 351 holds the plate die 32. The holder 351 holds the plate die 32 such that the plate die 32 is freely rotatable about its central axis. For example, the plate die 32 is attached to the holder 351 via a shaft member 353. The cylinder 352 is connected to the holder 351. The cylinder 352 is configured to be capable of being stretched and contracted. Due to stretch or contraction of the cylinder 352, the plate die 32 is moved together with the holder 351 in the radial direction of the workpiece material 20. The cylinder 352 may be a hydraulic cylinder or electric cylinder.

FIG. 2C is a perspective view showing the workpiece material 20, the axial press die 31, and the plate die 32. As shown in FIG. 2C, the plate die 32 has a disk shape in this embodiment. However, the plate die 32 need not necessarily have a disk shape, and may have, for example, a polygonal plate shape. The plate die 32 preferably has an axisymmetric shape. In an example of this embodiment, the plate die 32 is provided with a through hole 321 through which the shaft member 353 (FIG. 2B) is to be inserted.

Returning to FIG. 2B, in the processing step, the workpiece material 20 is pressed by the axial press die 31 in the axial direction, and the plate die 32 is pressed into the circumferential wall 21 of the workpiece material 20 while the workpiece material 20 is rotated relative to the plate die 32 about the central axis. More specifically, the large-diameter portion 312 of the axial press die 31 is brought into contact with the open end of the workpiece material 20 by stretching the cylinder 341, and the workpiece material 20 is pressed in the axial direction between the large-diameter portion 312 and the holder 331. At the same time, the plate die 32 is brought close to the circumferential wall 21 of the workpiece material 20 together with the holder 351 by stretching the cylinder 352, and the circumferential wall 21 is pressed inward in the radial direction by the plate die 32. During this time, the rotor 332 is driven, and the workpiece material 20 is rotated about the central axis together with the holder 331. The plate die 32 is rotated about the shaft member 353 due to contact with the workpiece material 20 rotated about the central axis.

FIG. 2D and FIG. 2E are cross-sectional views of the plate die 32 when pressed into the circumferential wall 21 of the workpiece material 20, taken along the thickness direction. FIG. 2D and FIG. 2E illustrate enlarged views of portions of the workpiece material 20 and the plate die 32.

As shown in FIG. 2D, the plate die 32 includes surfaces 322 and 323 and an end surface 324. The surface 322 extends substantially in the radial direction of the workpiece material 20 in a cross-sectional view of the workpiece material 20 and the plate die 32. The surface 323 is a surface located on a side opposite to the surface 322. The surface 323 also extends substantially in the radial direction of the workpiece material 20. The end surface 324 connects the surfaces 322 and 323. The end surface 324 faces the circumferential wall 21 of the workpiece material 20 from the outside in the radial direction.

The end surface 324 includes shoulder portions 324a and 324b. The shoulder portions 324a and 324b each have an arc shape in a cross-sectional view of the plate die 32. The shoulder portion 324a is continuous with the surface 322, which is one surface of the plate die 32. The shoulder portion 324b is continuous with the surface 323, which is the other surface of the plate die 32. The shoulder portion 324b is also continuous with the shoulder portion 324a. That is to say, in an example of this embodiment, the end surface 324 is composed of only the shoulder portions 324a and 324b.

The shoulder portions 324a and 324b each have a radius of curvature Rp (mm). In this embodiment, the radius of curvature Rp of each of the shoulder portions 324a and 324b is half of the thickness of the plate die 32, namely half of the distance between the surfaces 322 and 323. The thickness of the plate die 32 is preferably 0.1 mm or more from the viewpoint of securing the strength of the plate die 32.

As shown in FIG. 2E, the plate die 32 is pressed into the circumferential wall 21 of the workpiece material 20. More specifically, the plate die 32 is inserted into the gap between the small-diameter portion 311 and the electrode body 12 from the outside of the circumferential wall 21 with the small-diameter portion 311 of the axial press die 31 and the electrode body 12 supporting the circumferential wall 21 from the inside. The bead 113 is thus formed.

When the plate thickness of the circumferential wall 21 of the workpiece material 20 is represented by t (mm), and the pressing amount of the plate die 32 is represented by X (mm), the plate thickness t and the pressing amount X satisfy the following formulae (1) and (2) in terms of the relationship with the radius of curvature Rp(FIG. 2D) of each of the shoulder portions 324a and 324b. The pressing amount X is a distance in the radial direction of the workpiece material 20 between the outer circumferential surface of the circumferential wall 21 of the workpiece material 20 and a portion of the plate die 32 that is located at the innermost position inside the workpiece material 20 when the plate die 32 is stopped after pressed into the circumferential wall 21.

$$0.2 \leq Rp / t \qquad ( 1 )$$

$$X / Rp \leq 20.5 \qquad ( 2 )$$

As described above, in the processing step, the plate die 32 is pressed into the workpiece material 20 in the radial direction, whereas the axial press die 31 presses the workpiece material 20 in the axial direction. The axial press die 31 and the plate die 32 are moved relative to the workpiece material 20 by predetermined distances in the axial direction and the radial direction, respectively, and are stopped at the same time. When the pressing speed of the axial press die 31 is represented by V1 (mm/sec) and the pressing speed of the plate die 32 is represented by V2 (mm/sec), it is preferable that the pressing speeds V1 and V2 satisfy the following formula (3).

$$1.5 \leq V 2 / V 1 \qquad ( 3 )$$

The pressing speed of the axial press die 31 and the pressing speed of the plate die 32 may be constant or non-constant. The pressing speeds may be changed gradually or stepwise. For example, the pressing speeds at the final stage of the processing step can also be made faster than the pressing speeds at the initial stage. When the pressing speed of the axial press die 31 is non-constant, the pressing speed V1 in the formula (3) can be the average pressing speed of the axial press die 31. Similarly, when the pressing speed of the plate die 32 is non-constant, the pressing speed V2 in the formula (3) can be the average pressing speed of the plate die 32. The pressing speed V1 of the axial press die 31 is not particularly limited, but is, for example, 30 mm/sec or less. The pressing speed V2 of the plate die 32 may be determined in accordance with the pressing speed V1 of the axial press die 31.

With such a processing step, as shown in FIG. 2F, the cylindrical member 10 with the bead 113 formed on the circumferential wall 111 can be obtained.

### (Crimping Step)

The cylindrical member 10 may be subjected to a crimping step after the processing step. Referring to FIG. 2G, in the crimping step, the sealing body 13 is disposed on the bead 113 in the circumferential wall 111. By bending the open end portion of the circumferential wall 111 inward in the radial direction in this state, the sealing body 13 can be crimped and fixed to the workpiece material 20. Thus, the cylindrical member 10 (FIG. 1) serving as a battery is manufactured.

### Effects

In the method for manufacturing the cylindrical member 10 according to this embodiment, the ratio (Rp/t) between the plate thickness t of the circumferential wall 21 of the workpiece material 20 and the radius of curvature Rp of each of the end-surface shoulder portions 324a and 324b of the plate die 32 is 0.20 or greater, and the radius of curvature Rp of each of the end-surface shoulder portions 324a and 324b is sufficiently secured relative to the plate thickness t. That is to say, in the circumferential wall 21 of the workpiece material 20, regions are formed by the end-surface shoulder portions 324a and 324b and into which tensile strain is introduced are relatively large in size. Accordingly, when the tensile strain amount introduced to the circumferential wall 21 by the plate die 32 in the processing step is made constant, the tensile strain can be dispersed compared with a case where the radius of curvature Rp is small relative to the plate thickness t. Therefore, it is possible to suppress the formation of a crack and the occurrence of a necking defect in the bead 113 formed by the plate die 32.

Since Rp/t is 0.20 or greater in the method for manufacturing the cylindrical member 10 according to this embodiment, the plate thickness t of the circumferential wall 21 of the workpiece material 20 is moderately small relative to the radii of curvature Rp of the end-surface shoulder portions 324a and 324b of the plate die 32, and the distance from the neutral axis of bending to the surface of the bead 113 can be reduced. Accordingly, the difference between the neutral axis line length and the surface line length of the bead 113 is small, thus making it possible to reduce the amount of tensile strain introduced to regions bent by the end-surface shoulder portions 324a and 324b in the circumferential wall 21 of the workpiece material 20. Thus, it is possible to suppress the formation of a crack and the occurrence of a necking defect in the bead 113.

Rp/t is not particularly limited, but can be set to, for example, 200.00 or smaller (Rp/t≤200.00). In this case, it is possible to moderately secure the difference in the line length between the neutral axis of bending and the surface of the bead 113 and to cause sufficient deformation in the bead 113. Accordingly, after the axial press die 31 and the plate die 32 are removed from the cylindrical member 10, large springback is less likely to occur in the bead 113.

In the method for manufacturing a cylindrical member 10 according to this embodiment, the ratio (X/Rp) between the radius of curvature Rp of each of the end-surface shoulder portions 324a and 324b of the plate die 32 and the pressing amount X of the plate die 32 pressed into the circumferential wall 21 of the workpiece material 20 is 20.5 or smaller. That is to say, the pressing amount X of the plate die 32 is not too large relative to the radius of curvature Rp of each of the end-surface shoulder portions 324a and 324b. Accordingly, the tensile stress generated in regions bent by the end-surface shoulder portions 324a and 324b in the circumferential wall 21 of the workpiece material 20 is reduced. Thus, it is possible to suppress the formation of a crack and the occurrence of a necking defect in the bead 113.

In the method for manufacturing the cylindrical member 10 according to this embodiment, X/Rp is 20.5 or smaller and the pressing amount X of the plate die 32 is not too large, thus making it possible to prevent the circumferential length of the bead 113 formed by the plate die 32 from being excessively reduced. Accordingly, it is less likely that an excessive amount of the material is present at the bead 113, thus making it possible to suppress a phenomenon in which the bead 113 buckles and undulates in the circumferential direction of the cylindrical member 10.

X/Rp is not particularly limited, but can be set to, for example, 1.1 or greater (1.1≤X/Rp). In this case, in the bead 113 formed by the plate die 32, a straight portion for placement of a component such as the sealing body 13 is likely to be secured.

In the method for manufacturing the cylindrical member 10 according to this embodiment, it is preferable that the ratio (V2/V1) between the pressing speed V1 of the axial press die 31 in the axial direction and the pressing speed V2 of the plate die 32 in the radial direction against the workpiece material 20 is 1.5 or greater. In this case, the pressing speed V1 in the axial direction is not too large relative to the pressing speed V2 in the radial direction. Accordingly, it is possible to suppress the occurrence of the surplus material at the bead 113 caused through excessive pressing of the workpiece material 20 in the axial direction. Thus, it is possible to reduce poor die conformability in the bead 113.

V2/V1 is not particularly limited, but can be set to, for example, 10.0 or smaller (V2/V1≤10.0). In this case, insufficient pressing by the axial press die 31 and material shortage caused thereby in the bead 113 are less likely to occur, and the bead 113 is much less likely to crack.

As described above, with the method for manufacturing the cylindrical member 10 according to this embodiment, it is possible to suppress the formation of a crack and the occurrence of buckling and poor die conformability in the bead 113, thus making it possible to accurately form the bead 113. For example, when the workpiece material 20 is made of a relatively hard material such as a steel plate having a tensile strength of 290 MPa or more, the formation of a crack and the like are likely to occur in the bead 113, and therefore, the effects of the manufacturing method according to this embodiment are particularly likely to be exhibited. Accurate formation of the bead 113 makes it possible to, for example, stably place a component such as the sealing body 13 on the bead 113 and secure the pressure resistance and strength of the cylindrical member 10 as designed.

### Second Embodiment

In the first embodiment above, the bead 113 is finished into the final shape by pressing the plate die 32 into the workpiece material 20 in the radial direction only once in the processing step. Meanwhile, in this embodiment, pressing using the plate die 32 is conducted a plurality of times in the processing step.

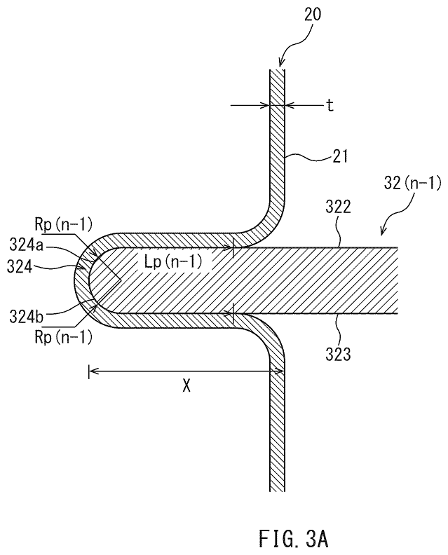

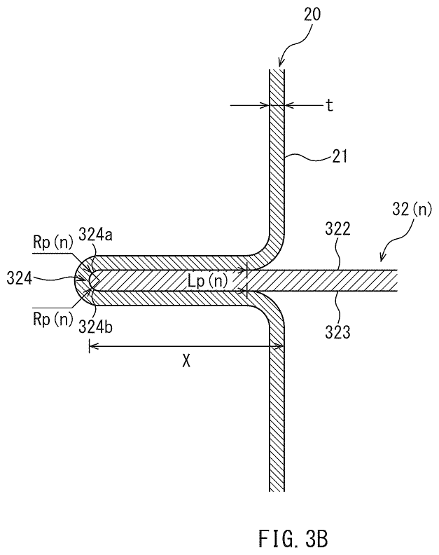

As illustrated in FIG. 3A and FIG. 3B, when pressing using the plate die 32 is conducted a plurality of times in the processing step, the shape of a plate die 32(n) to be used for the n-th pressing is different from the shape of a plate die 32(n-1) to be used for the (n-1)th pressing (n=natural number, n≥2). More specifically, the plate dies 32(n) and 32(n-1) are configured such that the following formulae (4) and (5) are satisfied.

$$Lp ( n ) \leq Lp ( n - 1 ) \times 1.1 \qquad ( 4 )$$

$$Rp ( n ) < Rp ( n - 1 ) \qquad ( 5 )$$

Referring to FIG. 3A, Lp(n-1) in the formula (4) is the surface line length of a portion of the plate die 32(n-1) to be pressed into the circumferential wall 21 of the workpiece material 20 in a cross-sectional view, namely the line length of a portion to be in contact with the circumferential wall 21. In the formula (5), Rp(n-1) is the radius of curvature (mm) of each of the end-surface shoulder portions 324a and 324b of the plate die 32(n-1). The radius of curvature Rp(n-1) satisfies the formula (1) and the formula (2) described in the first embodiment in terms of the relationship with the plate thickness t of the circumferential wall 21 of the workpiece material 20 and the pressing amount X of the plate die 32(n-1).

Referring to FIG. 3B, Lp(n) in the formula (4) is the surface line length of a portion of the plate die 32(n) to be pressed into the circumferential wall 21 of the workpiece material 20 in a cross-sectional view, namely the line length (mm) of a portion to be in contact with the circumferential wall 21. Lp(n) is generally greater than or equal to Lp(n-1) (Lp(n)≥Lp(n-1)). In the formula (5), Rp(n) is the radius of curvature (mm) of each of the end-surface shoulder portions 324a and 324b of the plate die 32(n). The radius of curvature Rp(n) satisfies the formula (1) and the formula (2) described in the first embodiment in terms of the relationship with the plate thickness t of the circumferential wall 21 of the workpiece material 20 and the pressing amount X of the plate die 32(n).

The plate die 32(n) need only be disposed so as to come into contact with the circumferential wall 21 of the workpiece material 20 subsequently to the plate die 32(n-1). For example, the plate die 32(n-1) and the plate die 32(n) may be disposed with a gap therebetween around the workpiece material 20 rotating about the central axis such that the plate die 32(n) comes into contact with the circumferential wall 21 after the plate die 32(n-1) has come into contact with the circumferential wall 21. Alternatively, the following procedure may be employed: after the workpiece material 20 is rotated once in a state in which the plate die 32(n-1) is in contact with the circumferential wall 21 and then the plate die 32(n-1) is separated from the circumferential wall 21, the plate die 32(n) is brought into contact with the circumferential wall 21 and then the workpiece material 20 is rotated once.

With this embodiment, the circumferential wall 21 of the workpiece material 20 can be subjected to the stepwise bead processing with the radius of curvature being changed from a relatively large one to a relatively small one. In this manner, by bending the circumferential wall 21 with a large radius of curvature first, tensile strain is dispersed, thus making it possible to suppress a decrease in the plate thickness of the circumferential wall 21. Also, conducting the multistage bead processing with substantially no change or only minor change of the surface line length of a portion of the plate die 32 to be pressed into the circumferential wall 21 of the workpiece material 20 makes it possible to suppress tensile deformation in each stage of the bead processing to form the bead 113 having a desired shape while keep the degree of a decrease in the plate thickness of the circumferential wall 21 caused by the first stage of the bead processing, namely the bead processing with the maximum radius of curvature. Accordingly, it is possible to effectively suppress the formation of a crack in the bead 113.

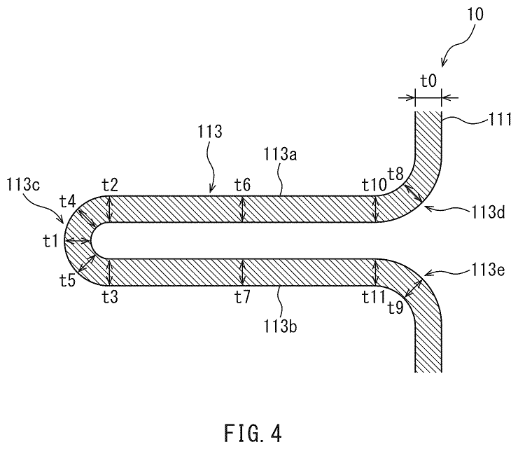

With this embodiment, it is possible to reduce the degree of a decrease in the plate thickness at the bead 113. Referring to FIG. 4, the bead 113 includes straight portions 113a and 113b extending in the radial direction of the cylindrical member 10, and a distal end portion 113c connecting the straight portions 113a and 113b. The straight portions 113a and 113b are portions shaped by the surfaces 322 and 323 (FIG. 3A and FIG. 3B) of the plate die 32, respectively. The distal end portion 113c is a portion shaped by the end surface 324 (FIG. 3A and FIG. 3B) of the plate die 32. At least portions of the distal end portion 113c that are continuous with the straight portions 113a and 113b have an arc shape in a cross-sectional view. In an example shown in FIG. 4, the entire distal end portion 113c has an arc shape in a cross-sectional view.

The plate thickness of the distal end portion 113c of the bead 113 is 80% or more and 100% or less of the plate thickness t0 of the circumferential wall 111 of the cylindrical member 10. The plate thickness of the distal end portion 113c of the bead 113 may be 95% or less or 90% or less of the plate thickness to of the circumferential wall 111 of the cylindrical member 10. The plate thickness of the distal end portion 113c of the bead 113 includes the plate thickness t1 measured at the apex of the distal end portion 113c, the plate thickness t2 measured at the boundary between the distal end portion 113c and the straight portion 113a, the plate thickness t3 measured at the boundary between the distal end portion 113c and the straight portion 113b, the plate thickness t4 measured just at the middle between the measurement position for the plate thickness t1 and the measurement position for the plate thickness t2, and the plate thickness t5 measured just at the middle between the measurement position for the plate thickness t1 and the measurement position for the plate thickness t3. In the cylindrical member 10 manufactured using the manufacturing method according to this embodiment, the plate thicknesses t1, t2, t3, t4, and t5 are 80% or more and 100% or less of the plate thickness to of the circumferential wall 111. The plate thicknesses t6 and t7 measured in the straight portions 113a and 113b, the plate thicknesses t8 and t9 measured at base portions 113d and 113e of the bead 113, and the plate thicknesses t10 and t11 measured at the boundaries between the straight portions 113a and 113b and the base portions 113d and 113e are also 80% or more and 100% or less of the plate thickness to of the circumferential wall 111. The plate thicknesses t6, t7, t8, 19, t10, and t11 may also be, for example, 95% or less or 90% or less of the plate thickness t0 of the circumferential wall 111 as in the case of the plate thickness of the distal end portion 113c of the bead 113.

Although embodiments of the present disclosure have been described above, the present disclosure is not limited to the above-described embodiments, and various modifications can be made without departing from the spirit of the present disclosure.

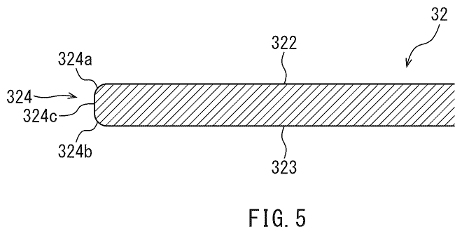

In the embodiments above, the end surface 324 of the plate die 32 is composed of only the shoulder portions 324a and 324b. However, as shown in FIG. 5, only portions of the end surface 324 may form the shoulder portions 324a and 324b. In this case, the radius of curvature Rp of the shoulder portion 324a is less than half of the thickness of the plate die 32. Similarly, the radius of curvature Rp of the shoulder portion 324b is also less than half of the thickness of the plate die 32. For example, the shoulder portions 324a and 324b are connected by a linear portion 324c in a cross-sectional view of the plate die 32. In this case as well, the radii of curvature Rp of the shoulder portions 324a and 324b each satisfy the formula (1) and the formula (2) above in terms of the relationship with the plate thickness t of the circumferential wall 21 of the workpiece material 20 and the pressing amount X of the plate die 32.

In the embodiments above and the example shown in FIG. 5, the radius of curvature Rp of the shoulder portion 324a is the same as the radius of curvature Rp of the shoulder portion 324b. However, the radius of curvature Rp of the shoulder portion 324a may be different from the radius of curvature Rp of the shoulder portion 324b. Depending on the use or the like of the manufactured cylindrical member 10, the radii of curvature Rp of the shoulder portions 324a and 324b are, for example, 0.5 mm or more. The central angles of the shoulder portions 324a and 324b are preferably 10° or more. The central angles of the shoulder portions 324a and 324b are 90° or less.

In the embodiments above, the cylindrical member 10 is a battery. In the processing step of forming the bead 113, the electrode body 12 functions as a core die that supports the circumferential wall 21 of the workpiece material 20 from the inner circumferential side. However, the cylindrical member 10 need not necessarily be a battery. For example, when the cylindrical member 10 is a pipe, a pipe joint, or the like, a core die other than the electrode body 12 can be used in the formation of the bead 113.

In the embodiments above, in the processing step of forming the bead 113, the small-diameter portion 311 of the axial press die 31 also functions as a core die that supports the circumferential wall 21 of the workpiece material 20 from the inner circumferential side. However, a core die separate from the axial press die 31 may be used to support the circumferential wall 21 of the workpiece material 20. The axial press die 31 need not necessarily include the small-diameter portion 311 and the large-diameter portion 312 as long as it can press the workpiece material 20 in the axial direction.

In the embodiments above, the workpiece material 20 and the cylindrical member 10 have a bottomed cylindrical shape. That is to say, the workpiece material 20 and the cylindrical member 10 includes the bottom plates 22 and 112, respectively. However, the bottom plates 22 and 112 can also be eliminated from the workpiece material 20 and the cylindrical member 10. For example, when the cylindrical member 10 is a pipe, a pipe joint, or the like, the workpiece material 20 and the cylindrical member 10 have a bottomless cylindrical shape.

In the embodiments above, the axial press die 31 is moved toward the workpiece material 20, and thus the axial press die 31 presses the workpiece material 20 in the axial direction. However, the workpiece material 20 may be pressed by the axial press die 31 in the axial direction by moving the workpiece material 20 toward the axial press die 31. Alternatively, the workpiece material 20 can also be pressed in the axial direction by moving both the axial press die 31 and the workpiece material 20. Similarly, when the plate die 32 is pressed into the circumferential wall of the workpiece material 20, the plate die 32 may be moved toward the workpiece material 20 as in the embodiments above, or the workpiece material 20 may be moved toward the plate die 32, or both the plate die 32 and the workpiece material 20 may be moved.

In the embodiments above, in the processing step of forming the bead 113, the workpiece material 20 is rotated about its central axis. However, it is also possible to revolve the plate die 32 about the central axis of the workpiece material 20 in the state in which the workpiece material 20 is allowed to stand still. In the bead processing, the workpiece material 20 need only be rotated in its central axis relative to the plate die 32.

### EXAMPLES

Hereinafter, the present disclosure will be described in more detail with reference to examples. However, the present disclosure is not limited to the following examples.

### First Example

Regarding the method for manufacturing a cylindrical member described in the first embodiment, the CAE analysis was conducted using commercially available analysis software (LS-DYNA, manufactured by JSOL Corporation) to evaluate the formation of a crack and the occurrence of buckling in the circumferential direction in the bead.

The common conditions for the CAE analysis are as follows.

### (Workpiece Material)

Shape: bottomed cylindrical shape
Raw material: nickel-plated steel plate
Tensile strength: 330 MPa
Plate thickness t: 0.4 mm
Outer diameter: 40 mm
Height: 30 mm

### (Bead Processing)

Lubricating oil: none
Pressing speed V1 of axial press die: 7.5 mm/s
Pressing speed V2 of plate die: 7.5 mm/s

Table 1 shows other analysis conditions and evaluation results.

TABLE 1

| | Plate die | | | | | | |
|---|---|---|---|---|---|---|---|
| | Radius of | Pressing | | | | | |
| | curvature Rp | amount X | | | Evaluation | | |
| No. | (mm) | (mm) | Rp/t | X/Rp | Crack | Buckling | Note |
| 1 | 0.06 | 1.52 | 0.15 | 25.3 | Yes | No | Comp. Ex. |
| 2 | 0.06 | 1.60 | 0.15 | 26.7 | Yes | No | Comp. Ex. |
| 3 | 0.06 | 1.68 | 0.15 | 28.0 | Yes | No | Comp. Ex. |
| 4 | 0.06 | 2.10 | 0.15 | 35.0 | Yes | No | Comp. Ex. |
| 5 | 0.08 | 1.52 | 0.20 | 19.0 | No | No | Ex. |
| 6 | 0.08 | 1.60 | 0.20 | 20.0 | No | No | Ex. |
| 7 | 0.08 | 1.68 | 0.20 | 21.0 | No | Yes | Comp. Ex. |
| 8 | 0.08 | 2.10 | 0.20 | 26.3 | No | Yes | Comp. Ex. |
| 9 | 0.10 | 1.52 | 0.25 | 15.2 | No | No | Ex. |
| 10 | 0.10 | 1.60 | 0.25 | 16.0 | No | No | Ex. |
| 11 | 0.10 | 1.68 | 0.25 | 16.8 | No | No | Ex. |
| 12 | 0.10 | 2.10 | 0.25 | 21.0 | No | Yes | Comp. Ex. |

As shown in Table 1, in the examples in which the ratio (Rp/t) between the plate thickness t of the circumferential wall of the workpiece material and the radius of curvature Rp of the end-surface shoulder portion of the plate die was 0.20 or greater and the ratio (X/Rp) between the radius of curvature Rp of the end-surface shoulder portion and the pressing amount X of the plate die was 20.5 or smaller, the bead neither cracked nor buckled in the circumferential direction. Meanwhile, in the comparative examples in which Rp/t was smaller than 0.20, the bead cracked. Also, in the comparative examples in which X/Rp was greater than 20.5, the bead buckled in the circumferential direction.

It is found from the results of this analysis that it is possible to suppress both the formation of a crack and the occurrence of buckling in the case of 0.20≤Rp/t and X/Rp≤20.5.

### Second Example

Regarding the method for manufacturing a cylindrical member described in the first embodiment, the CAE analysis was conducted using the same analysis software as that in the first example with the pressing speed V1 of the axial press die and the pressing speed V2 of the plate die being varied. In this analysis, it was evaluated whether or not poor die conformability occurred in the bead. More specifically, when the radius of curvature of bending at the distal end portion of the bead in the workpiece material (this radius of curvature is referred to as “bending R”) was smaller than half of the radius of curvature Rp of the end-surface shoulder portion of the plate die, it was determined that the poor die conformability occurred. Table 2 shows the analysis conditions and evaluation results. The conditions other than the pressing speeds V1 and V2 were the same as those in No. 9 in the first example (Table 1).

TABLE 2

| | Pressing | Pressing | | Radius of | Bending R (mm) | |
|---|---|---|---|---|---|---|
| | speed V1 | speed V2 | | curvature Rp (mm) | of distal end | Poor die |
| No. | (mm/s) | (mm/s) | V2/V1 | of plate die | portion of bead | conformability |
| 13 | 6.0 | 10.0 | 1.7 | 0.10 | 0.07 | No |
| 14 | 6.0 | 15.0 | 2.5 | 0.10 | 0.08 | No |
| 15 | 6.0 | 20.0 | 3.3 | 0.10 | 0.09 | No |
| 16 | 6.5 | 10.0 | 1.5 | 0.10 | 0.05 | No |
| 17 | 6.5 | 15.0 | 2.3 | 0.10 | 0.09 | No |
| 18 | 6.5 | 20.0 | 3.1 | 0.10 | 0.09 | No |
| 19 | 7.0 | 10.0 | 1.4 | 0.10 | 0.04 | Yes |
| 20 | 7.0 | 15.0 | 2.1 | 0.10 | 0.08 | No |
| 21 | 7.0 | 20.0 | 2.9 | 0.10 | 0.09 | No |
| 22 | 7.5 | 10.0 | 1.3 | 0.10 | 0.03 | Yes |
| 23 | 7.5 | 15.0 | 2.0 | 0.10 | 0.08 | No |
| 24 | 7.5 | 20.0 | 2.7 | 0.10 | 0.09 | No |

As shown in Table 2, when the ratio (V2/V1) between the pressing speed V1 of the axial press die and the pressing speed V2 of the plate die was smaller than 1.5, the poor die conformability occurred in the bead. Meanwhile, when V2/V1 was 1.5 or greater, the poor die conformability did not occur in the bead. Accordingly, it is found that it is possible to prevent the poor die conformability in the bead in the case of 1.5≤V2/V1.

### Third Example

Regarding the method for manufacturing a cylindrical member described in the second embodiment, the CAE analysis was conducted using the same analysis software as that in the first example. In this analysis, the plate thickness reduction rate in the bead was evaluated. More specifically, the plate thicknesses t1 to t11 (FIG. 4) of the predetermined portions of the bead having the final shape were measured, and the reduction rates from the plate thickness t of the circumferential wall of the workpiece material were calculated. Tables 3 and 4 show the analysis conditions and evaluation results. The basic conditions for the analysis were the same as those in No. 9 in the first example (Table 1).

TABLE 3
TABLE 3

| | | | | Maximum | |
|---|---|---|---|---|---|
| | | | | plate thick- | |
| | First | Second | Third | ness reduction | |
| No. | stage | stage | stage | rate (%) | Note |
| 25 | Rp = 0.10 | — | — | 22.00 | Rp in first stage: |
| | | | | | same as that in No. 9 |
| 26 | Rp = 0.20 | Rp = 0.10 | — | 19.50 | Rp in second stage: |
| | | | | | same as that in No. 9 |
| 27 | Rp = 0.30 | Rp = 0.20 | Rp = 0.10 | 18.30 | Rp in third stage: |
| | | | | | same as that in No. 9 |

TABLE 4
TABLE 4

| | No. 25 | No. 26 | No. 27 |
|---|---|---|---|
| t1 | 19.30 | 18.20 | 16.50 |
| t2 | 17.30 | 16.30 | 15.50 |
| t3 | 16.20 | 15.30 | 14.30 |
| t4 | 22.00 | 19.50 | 18.30 |
| t5 | 21.10 | 19.10 | 18.00 |
| t6 | 9.16 | 8.12 | 7.11 |
| t7 | 8.13 | 7.14 | 6.56 |
| t8 | 0.50 | 0.30 | 0.30 |
| t9 | 0.50 | 0.40 | 0.30 |
| t10 | 3.15 | 3.14 | 3.14 |
| t11 | 3.12 | 3.13 | 3.12 |

*Plate thickness reduction rate (%)

As shown in Table 3, single-stage bead processing was conducted in No. 25 under the same conditions as those of No. 9 (Table 1) of the first example, and two-stage bead processing and three-stage bead processing were conducted in No. 26 and No. 27, respectively. In No. 26 and No. 27, the radius of curvature Rp of the end-surface shoulder portion of the plate die was smaller in the later stage. In No. 26 and No. 27, the radius of curvature Rp in the final stage of the bead processing was the same as that in No. 9 in the first example. The surface line length of the portion pressed into the circumferential wall in the plate die was the same in the first stage, the second stage, and the third stage, and was the same as that in No. 9 in the first example.

As can be seen from Table 3, in the case of No. 26 and No. 27 in which the final bead shape was formed by conducting the bead processing a plurality of times, it was possible to reduce the maximum plate thickness reduction rate in the bead compared with No. 25 in which the final bead shape was formed by conducting the bead processing once.

As can be seen from Table 4, in the case of No. 26 and No. 27 in which the final bead shape was formed by conducting the bead processing a plurality of times, the plate thickness reduction rate was reduced at the predetermined portions of the bead compared with No. 25 in which the final bead shape was formed by conducting the bead processing once. More specifically, some of the reduction rates of the plate thicknesses t1 to t5 at the distal end portion of the bead relative to the plate thickness t of the workpiece material (plate thickness t0 of the circumferential wall of the cylindrical member) were 20% or more in No. 25, whereas all of them were less than 20% in No. 26 and No. 27. Regarding the plate thicknesses t6 to t11 of the portions other than the distal end portion in the bead, the plate thickness reduction rate was less than 20% in all of No. 25, No. 26, and No. 27.

As described above, when the final bead shape is formed by conducting the bead processing a plurality of times, it is possible to reduce a decrease in the plate thickness of the distal end portion of the bead. That is to say, it is possible to keep the plate thicknesses t1 to t5 at the distal end portion of the bead to 80% or more of the plate thickness t0 of the circumferential wall.

### REFERENCE SIGNS LIST

10: Cylindrical member
111: Circumferential wall
113: Bead
113c: Distal end portion
12: Electrode body
13: Sealing body
20: Workpiece material
21: Circumferential wall
31: Axial press die
32: Plate die
322: First surface
323: Second surface
324: End surface
324a: First shoulder portion
324b: Second shoulder portion

1. A manufacturing method for manufacturing a cylindrical member, comprising:
a preparation step of preparing a cylindrical workpiece material; and
a processing step of forming, in a circumferential wall of the workpiece material, a bead that has a shape inwardly protruding in a radial direction of the workpiece material and that extends in a circumferential direction of the workpiece material by pressing the workpiece material in an axial direction of the workpiece material by an axial press die, and pressing, into the circumferential wall, a plate die disposed outside of the circumferential wall in the radial direction while rotating the workpiece material about a central axis relative to the plate die,
wherein, in a cross-sectional view taken along a thickness direction of the plate die, the plate die includes:
a first surface that extends in the radial direction and has a linear shape;
a second surface that is located on a side opposite to the first surface, extends in the radial direction, and has a linear shape; and
an end surface that connects the first surface and the second surface, faces the circumferential wall, and includes an arc-shaped first shoulder portion continuous with the first surface and an arc-shaped second shoulder portion continuous with the second surface, and
when a radius of curvature of each of the first shoulder portion and the second shoulder portion is represented by Rp, a plate thickness of the circumferential wall is represented by t, and a pressing amount of the plate die in the processing step is represented by X, Rp, t, and X satisfy formulae (1) and (2) below:
$$0.2 \leq Rp / t \qquad ( 1 )$$
$$X / Rp \leq 20.5 . \qquad ( 2 )$$

2. The manufacturing method according to claim 1,
wherein, when a pressing speed of the axial press die is represented by V1 and a pressing speed of the plate die is represented by V2 in the processing step, V1 and V2 satisfy a formula (3) below:
$$1.5 \leq V 2 / V 1. \qquad ( 3 )$$

3. The manufacturing method according to claim 1,
wherein pressing using the plate die is conducted a plurality of times in the processing step, and
when, in a cross-sectional view taken along the thickness direction of the plate die to be used for n-th pressing, a surface line length of a portion to be pressed into the circumferential wall is represented by Lp(n) and a radius of curvature of each of the first shoulder portion and the second shoulder portion is represented by Rp(n), and in a cross-sectional view taken along the thickness direction of the plate die to be used for (n-1)th pressing, a surface line length of a portion to be pressed into the circumferential wall is represented by Lp(n-1) and a radius of curvature of each of the first shoulder portion and the second shoulder portion is represented by Rp(n-1), Lp(n), Rp(n), Lp(n-1), and Rp(n-1) satisfy formulae (4) and (5) below:
$$Lp ( n ) \leq Lp ( n - 1 ) \times 1.1 \qquad ( 4 )$$
$$Rp ( n ) < Rp ( n - 1 ) . \qquad ( 5 )$$

4. The manufacturing method according to claim 1,
wherein the workpiece material is made of a steel material having a tensile strength of 290 MPa or more.

5. The manufacturing method according to claim 1,
wherein the cylindrical member is a battery,
the workpiece material has a bottomed cylindrical shape and contains an electrode body, and
the manufacturing method further includes a step of placing a sealing body on the bead formed on the circumferential wall and bending an end portion of the circumferential wall in the axial direction inward in the radial direction to fix the sealing body to the workpiece material.

6. A cylindrical member, comprising:
a circumferential wall having a cylindrical shape; and
a bead that has a shape inwardly protruding from the circumferential wall in a radial direction of the circumferential wall and that extends in a circumferential direction of the circumferential wall,
wherein a plate thickness of a distal end portion of the bead is 80% or more and 100% or less of a plate thickness of the circumferential wall.

7. The manufacturing method according to claim 2,
wherein the cylindrical member is a battery,
the workpiece material has a bottomed cylindrical shape and contains an electrode body, and
the manufacturing method further includes a step of placing a sealing body on the bead formed on the circumferential wall and bending an end portion of the circumferential wall in the axial direction inward in the radial direction to fix the sealing body to the workpiece material.

8. The manufacturing method according to claim 3,
wherein the cylindrical member is a battery,
the workpiece material has a bottomed cylindrical shape and contains an electrode body, and
the manufacturing method further includes a step of placing a sealing body on the bead formed on the circumferential wall and bending an end portion of the circumferential wall in the axial direction inward in the radial direction to fix the sealing body to the workpiece material.

9. The manufacturing method according to claim 4,
wherein the cylindrical member is a battery,
the workpiece material has a bottomed cylindrical shape and contains an electrode body, and
the manufacturing method further includes a step of placing a sealing body on the bead formed on the circumferential wall and bending an end portion of the circumferential wall in the axial direction inward in the radial direction to fix the sealing body to the workpiece material.
